(19) United States
(12) Patent Application Publication
(10) Pub. No.: US 2015/0362849 A1
(43) Pub. Date: Dec. 17, 2015

(54) ELECTROPHOTOGRAPHIC PHOTOSENSITIVE MEMBER, METHOD FOR PRODUCING THE SAME, ELECTROPHOTOGRAPHIC APPARATUS AND PROCESS CARTRIDGE, AND CHLOROGALLIUM PHTHALOCYANINE CRYSTAL

(71) Applicant: CANON KABUSHIKI KAISHA, Tokyo (JP)

(72) Inventors: Tsutomu Nishida, Mishima-shi (JP); Masato Tanaka, Tagata-gun (JP); Masataka Kawahara, Mishima-shi (JP); Jumpei Kuno, Mishima-shi (JP); Kaname Watariguchi, Yokohama-shi (JP)

(21) Appl. No.: 14/735,989

(22) Filed: Jun. 10, 2015

(30) Foreign Application Priority Data
Jun. 13, 2014 (JP) 2014-122841
Oct. 29, 2014 (JP) 2014-220750

(51) Int. Cl. G03G 15/00

(52) U.S. Cl. CPC G03G 5/0696; G03G 5/047

(57) ABSTRACT

A photosensitive layer of an electrophotographic photosensitive member contains a particular chlorogallium phthalocyanine crystal in which an organic compound is contained. The organic compound has a Hansen solubility parameter δtotal of 24.0 or more and 35.0 or less, a polar energy δP of 13.5 or more and 21.0 or less, and a dispersion energy δD of 15.0 or more and 19.5 or less.

### BACKGROUND OF THE INVENTION

1. Field of the Invention

The present invention relates to an electrophotographic photosensitive member, a method for producing the electrophotographic photosensitive member, an electrophotographic apparatus and a process cartridge, and a chlorogallium phthalocyanine crystal.

2. Description of the Related Art

Phthalocyanine pigments having high sensitivity have been often used as charge generation materials used in electrophotographic photosensitive members. In particular, hydroxygallium phthalocyanine and chlorogallium phthalocyanine have excellent sensitivity characteristics, and various crystal forms have been reported.

Although electrophotographic photosensitive members that use such a phthalocyanine pigment have excellent sensitivity characteristics, photocarriers generated tend to be left in a photosensitive layer, which easily causes a potential variation such as a ghost memory.

Japanese Patent Laid-Open No. 5-194523 discloses a technique concerning a production method for treating chlorogallium phthalocyanine with an aromatic alcohol. Japanese Patent Laid-Open No. 7-209890 discloses a technique in which a chlorogallium phthalocyanine crystal is purified by sublimation.

However, the recent further improvement in image quality requires that image defects due to a ghost phenomenon are further overcome. As a result of studies conducted by the present inventors, it has been found that a ghost memory needs to be further overcome for the chlorogallium phthalocyanines disclosed in Japanese Patent Laid-Open No. 5-194523 and Japanese Patent Laid-Open No. 7-209890.

### SUMMARY OF THE INVENTION

The present invention provides an electrophotographic photosensitive member that suppresses a ghost memory, a method for producing the electrophotographic photosensitive member, and an electrophotographic apparatus and a process cartridge. The present invention also provides a particular chlorogallium phthalocyanine crystal in which an organic compound is contained.

In an aspect of the present invention, an electrophotographic photosensitive member includes a support and a photosensitive layer on the support. The photosensitive layer contains a chlorogallium phthalocyanine crystal in which an organic compound is contained. The organic compound has a Hansen solubility parameter δtotal of 24.0 or more and 35.0 or less. The organic compound has a polar energy δP of 13.5 or more and 21.0 or less. The organic compound has a dispersion energy δD of 15.0 or more and 19.5 or less. The chlorogallium phthalocyanine crystal is a compound represented by the following formula (1).

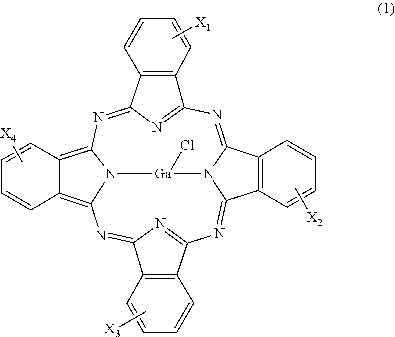

In the formula (1), X₁ to X₄ each independently represent a hydrogen atom or a chlorine atom.

In another aspect of the present invention, a process cartridge is detachably attachable to a main body of an electrophotographic apparatus and integrally supports the above-described electrophotographic photosensitive member and at least one selected from the group consisting of a charging device, a developing device, a transfer device, and a cleaning member.

In another aspect of the present invention, an electrophotographic apparatus includes the above-described electrophotographic photosensitive member, a charging device, an exposure device, a developing device, and a transfer device.

In another aspect of the present invention, a method for producing the electrophotographic photosensitive member includes an acid pasting step of mixing chlorogallium phthalocyanine with sulfuric acid to obtain hydroxygallium phthalocyanine.

In another aspect of the present invention, a chlorogallium phthalocyanine crystal contains an organic compound therein. The organic compound has a Hansen solubility parameter δtotal of 24.0 or more and 35.0 or less. The organic compound has a polar energy δP of 13.5 or more and 21.0 or less. The organic compound has a dispersion energy δD of 15.0 or more and 19.5 or less. The chlorogallium phthalocyanine crystal is a compound represented by the above formula (1).

According to the present invention, there can be provided an electrophotographic photosensitive member that suppresses a ghost memory, a method for producing the electrophotographic photosensitive member, and a process cartridge and an electrophotographic apparatus that include the electrophotographic photosensitive member. There can also be provided a particular chlorogallium phthalocyanine crystal in which a particular organic compound is contained.

Further features of the present invention will become apparent from the following description of exemplary embodiments with reference to the attached drawings.

### BRIEF DESCRIPTION OF THE DRAWINGS

FIG. 1 illustrates an example of a schematic structure of an electrophotographic apparatus that includes a process cartridge including an electrophotographic photosensitive member.

FIGS. 2A and 2B illustrate examples of layer structures of an electrophotographic photosensitive member.

FIG. 3 illustrates an image for evaluation used in Examples.

FIG. 4 illustrates an image of a similar knight jump pattern for forming a halftone image.

FIG. 5 illustrates an X-ray diffraction pattern of a chlorogallium phthalocyanine crystal obtained in a wet milling step in Example 1.

### DESCRIPTION OF THE EMBODIMENTS

In the present invention, a photosensitive layer of an electrophotographic photosensitive member includes a chlorogallium phthalocyanine crystal in which an organic compound is contained, and the chlorogallium phthalocyanine crystal is a compound represented by the following formula (1). Furthermore, the organic compound has a Hansen solubility parameter δtotal of 24.0 or more and 35.0 or less, a polar energy δP of 13.5 or more and 21.0 or less, and a dispersion energy δD of 15.0 or more and 19.5 or less.

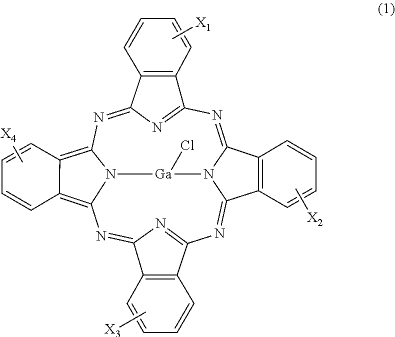

X₁ to X₄ in the formula (1) each independently represent a hydrogen atom or a chlorine atom.

The present inventors have found that, by adding an organic compound having a particular Hansen solubility parameter to a chlorogallium phthalocyanine crystal, residual carriers after irradiation with light, which result in a positive ghost, can be effectively suppressed. This may be because the organic compound in the crystal facilitates the movement of carriers remaining in or near the chlorogallium phthalocyanine crystal. When the chlorogallium phthalocyanine crystal is a compound represented by the above formula (1), the movement of carriers to the organic compound is effectively facilitated.

In the compound represented by the formula (1), for example, all of X₁ to X₄ represent a hydrogen atom or one of X₁ to X₄ represents a chlorine atom. Furthermore, the chlorogallium phthalocyanine crystal is particularly a mixture of the compound in which all of X₁ to X₄ represent a hydrogen atom and the compound in which one of X₁ to X₄ represents a chlorine atom. The chlorogallium phthalocyanine crystal may be used alone or as a mixture as long as the chlorogallium phthalocyanine crystal is a compound represented by the formula (1). Such a chlorogallium phthalocyanine crystal can produce an effect of suppressing a ghost memory.

The Hansen solubility parameter δtotal is a value indicating the solubility of a compound that is determined from latent heat of vaporization and molecular volume. The solubility between substances can be judged by this value. When δtotal of the organic compound is 24.0 or more and 35.0 or less, effects of the present invention can be produced. The reason for this may be as follows. The organic compound having δtotal in the above range with respect to δtotal (22.1) of the chlorogallium phthalocyanine has preferable compatibility with the chlorogallium phthalocyanine. Thus, the chlorogallium phthalocyanine crystal can contain the organic compound while maintaining the form of the crystal. If δtotal of the organic compound is less than 24.0 or more than 35.0, the crystallinity of the chlorogallium phthalocyanine degrades, which may inhibit the movement of carriers or make it difficult to take the organic compound into the crystal. In view of an effect of suppressing a ghost memory, δtotal of the organic compound is more preferably 24.2 or more and 30.0 or less.

The polar energy δP of the Hansen solubility parameter is a value based on polarization. When the polar energy δP of the organic compound is 13.5 or more and 21.0 or less, effects of the present invention can be produced. This may be because the organic compound having polar energy δP in the above range with respect to δP (12.0) of the chlorogallium phthalocyanine causes higher polarization than the chlorogallium phthalocyanine and thus can facilitate the movement of carriers. If the polar energy δP of the organic compound is less than 13.5, polarization that sufficiently causes the movement of carriers sometimes does not occur. If the polar energy δP of the organic compound is more than 21.0, carriers that have moved to the organic compound may be trapped due to high polarization. In view of an effect of suppressing a ghost memory, the polar energy δP of the organic compound is more preferably 14.0 or more and 18.0 or less.

The dispersion energy δD of the Hansen solubility parameter is a value based on the proximity force of Van Der Waals. When the dispersion energy δD of the organic compound is 15.0 or more and 19.5 or less, effects of the present invention can be produced. This may be because the organic compound having dispersion energy δD in the above range with respect to δD (18.4) of the chlorogallium phthalocyanine has a proximity force equal to that of the chlorogallium phthalocyanine in the chlorogallium phthalocyanine crystal and thus does not easily inhibit the formation of crystals. If the dispersion energy δD of the organic compound is less than 15.0, the organic compound cannot be stably present in the chlorogallium phthalocyanine crystal and the amount of the organic compound may decrease. If the dispersion energy δD is more than 19.5, only the organic compound is aggregated. Consequently, the crystallinity of the chlorogallium phthalocyanine crystal degrades, and the movement of carriers may be inhibited. In view of an effect of suppressing a ghost memory, the dispersion energy δD of the organic compound is more preferably 17.7 or more and 19.1 or less.

The Hansen solubility parameter is described in detail in Hansen, Charles (2007). Hansen Solubility Parameters: A user's handbook, Second Edition. Boca Raton, Fla.: CRC Press. ISBN 9780849372483. In the present invention, HSPiP (Hansen Solubility Parameters in Practice) Software 4th Edition 4.0.08 is used to determine the Hansen solubility parameter of the organic compound.

The phrase “the chlorogallium phthalocyanine crystal in which a particular organic compound is contained” means that a particular organic compound is taken into the crystal. The chlorogallium phthalocyanine crystal in which an organic compound is contained is obtained by subjecting an organic compound and chlorogallium phthalocyanine to a wet milling treatment. The wet milling treatment is a wet grinding treatment performed by mixing a chlorogallium phthalocyanine crystal, an organic compound, and spherical media.

Examples of the organic compound that satisfies the Hansen solubility parameter (δtotal, δP, δD) include N-methylformamide, N-methylacetamide, N-vinylformamide, 2-pyrrolidone, N-methylmethanesulfonamide, N-propylformamide, acetonitrile, and formamide. The value of the Hansen solubility parameter of each of the organic compounds is shown in Table 1. Among them, at least one of N-methylformamide and N-methylacetamide is particularly used.

TABLE 1

| | Hansen solubility parameter | | |
|---|---|---|---|
| Compound | δtotal | δP | δD |
| N-Methylformamide | 29.2 | 17.8 | 17.9 |
| N-Methylacetamide | 25.5 | 14.8 | 18.0 |
| N-Vinylformamide | 27.2 | 16.0 | 17.5 |
| 2-Pyrrolidone | 25.1 | 13.7 | 19.3 |
| N-Methylmethanesulfonamide | 27.5 | 18.4 | 17.5 |
| N-Propylformamide | 24.4 | 13.6 | 16.9 |
| Acetonitrile | 24.0 | 16.2 | 16.2 |
| Formamide | 33.7 | 20.3 | 17.7 |

The content of the organic compound is, for example, 0.1 mass % or more and 1.5 mass % or less based on the chlorogallium phthalocyanine in the chlorogallium phthalocyanine crystal. When the content is within the above range, it is believed that the movement of carriers is facilitated and thus a higher effect of suppressing a ghost memory is produced. The chlorogallium phthalocyanine in the chlorogallium phthalocyanine crystal is a component other than the organic compound in the chlorogallium phthalocyanine crystal in which the organic compound is contained.

In the present invention, the content of the organic compound in the chlorogallium phthalocyanine crystal is determined by analyzing the H-NMR measurement data of the chlorogallium phthalocyanine crystal. The measurement is performed under the following conditions.

### H-NMR Measurement

Measurement instrument used: AVANCE III 500 manufactured by BRUKER
Solvent: sulfuric acid-d2 (D₂SO₄)

The chlorogallium phthalocyanine crystal is, for example, a chlorogallium phthalocyanine crystal having four major peaks at Bragg angles 2θ±0.2° of 7.4°, 16.6°, 25.5°, and 28.4° in CuKα X-ray diffraction. Such a chlorogallium phthalocyanine crystal having the particular peaks sufficiently produces an effect of suppressing ghost.

The X-ray diffraction of the chlorogallium phthalocyanine crystal according to an embodiment of the present invention is measured under the following conditions.

### Powder X-Ray Diffraction Measurement

Measurement instrument used: X-ray diffractometer RINT-TTR II manufactured by Rigaku Corporation
X-ray tube: Cu
Tube voltage: 50 kV
Tube current: 300 mA
Scanning mode: 2θ/θ scan
Scanning speed: 4.0°/min
Sampling step size: 0.02°
Start angle (2θ): 5.0°
Stop angle (2θ): 40.0°
Attachment: standard sample holder
Filter: nonuse
Incidence monochromator: use
Counter monochromator: nonuse
Divergence slit: open
Divergence vertical limitation slit: 10.00 mm
Scattering slit: open
Receiving slit: open
Counter: scintillation counter

The chlorogallium phthalocyanine crystal according to an embodiment of the present invention is, for example, a chlorogallium phthalocyanine crystal obtained through an acid pasting step in which hydroxygallium phthalocyanine is obtained by mixing chlorogallium phthalocyanine with sulfuric acid. For example, concentrated sulfuric acid is used as the sulfuric acid in view of solubility of chlorogallium phthalocyanine.

Furthermore, the chlorogallium phthalocyanine crystal according to an embodiment of the present invention is, for example, a chlorogallium phthalocyanine crystal obtained by performing the following synthesis step, the above-described acid pasting step, the following hydrochloric acid treatment step, and the following wet milling step in that order. The synthesis step is a step of synthesizing chlorogallium phthalocyanine by reacting a gallium compound and a compound that forms a phthalocyanine ring in a chlorinating aromatic compound. The hydrochloric acid treatment step is a step of mixing the hydroxygallium phthalocyanine obtained in the acid pasting step and an aqueous hydrochloric acid solution to obtain chlorogallium phthalocyanine. The wet milling step is a step of mixing the chlorogallium phthalocyanine obtained in the hydrochloric acid treatment step and an organic compound and performing a wet milling treatment. The chlorogallium phthalocyanine crystal obtained through these steps produces a good effect of suppressing ghost. In the hydrochloric acid treatment step, hydroxygallium phthalocyanine and an aqueous hydrochloric acid solution react with each other, and thus chlorogallium phthalocyanine is obtained.

In the synthesis step, the gallium compound is, for example, gallium trichloride. For example, the compound that forms a phthalocyanine ring is orthophthalonitrile and the chlorinating aromatic compound is α-chloronaphthalene.

In the hydrochloric acid treatment step, the concentration of the aqueous hydrochloric acid solution mixed with the hydroxygallium phthalocyanine is preferably 10 mass % or more and more preferably 30 mass % or more in view of reactivity. The aqueous hydrochloric acid solution can be mixed by milling or stirring. Regarding the amount of the aqueous hydrochloric acid solution added, the amount of hydrochloric acid (HCl) in the aqueous hydrochloric acid solution is preferably 10 mol or more and more preferably 100 mol or more based on 1 mol of the hydroxygallium phthalocyanine.

The chlorogallium phthalocyanine crystal according to an embodiment of the present invention is a novel crystal in which the organic compound is contained. Specifically, the organic compound has a Hansen solubility parameter total of 24.0 or more and 35.0 or less, a polar energy δP of 13.5 or more and 21.0 or less, and a dispersion energy δD of 15.0 or more and 19.5 or less, and the chlorogallium phthalocyanine is a compound represented by the above formula (1).

The chlorogallium phthalocyanine crystal according to an embodiment of the present invention has an excellent function as a photoconductor, and thus can be applied to solar cells, sensors, switching elements, and the like in addition to electrophotographic photosensitive members.

Next, the case where the chlorogallium phthalocyanine crystal according to an embodiment of the present invention is used as a charge generation material of the electrophotographic photosensitive member will be described.

The electrophotographic photosensitive member according to an embodiment of the present invention includes a support and a photosensitive layer.

The photosensitive layer is classified into a single-layer type photosensitive layer containing both a charge transport material and a charge generation material and a multilayer type (function-separated) photosensitive layer separately including a charge generating layer containing a charge generation material and a charge transporting layer containing a charge transport material. A multilayer type photosensitive layer including a charge generating layer and a charge transporting layer formed on the charge generating layer is particularly employed in view of electrophotographic characteristics.

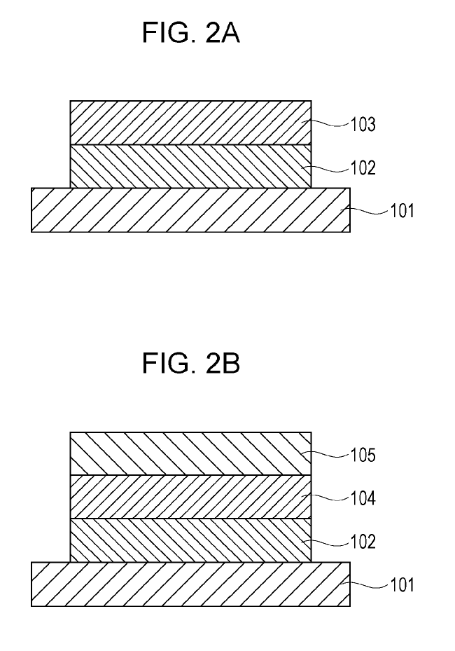

FIGS. 2A and 2B illustrate examples of layer structures of the electrophotographic photosensitive member according to an embodiment of the present invention. FIG. 2A illustrates a single-layer type photosensitive layer in which an undercoat layer 102 is formed on a support 101 and a photosensitive layer 103 is formed on the undercoat layer 102. FIG. 2B illustrates a multilayer type photosensitive layer in which an undercoat layer 102 is formed on the support 101, a charge generating layer 104 is formed on the undercoat layer 102, and a charge transporting layer 105 is formed on the charge generating layer 104.

### Support

The support is, for example, a support having electrical conductivity (conductive support). The support may be, for example, a support made of a metal or an alloy such as aluminum or stainless steel. The support may also be a support obtained by coating a metal, a plastic, or paper with a conductive film.

The shape of the support is, for example, a cylindrical shape or a film-like shape.

A conductive layer may be disposed between the support and an undercoat layer described below in order to cover unevenness on the surface of the support and suppress interference fringes. The conductive layer can be formed by forming a coating film of a conductive layer-forming coating liquid prepared by dispersing conductive particles, a binder resin, and a solvent and then drying/curing the coating film.

Examples of the conductive particles include aluminum particles, titanium oxide particles, tin oxide particles, zinc oxide particles, carbon black, and silver particles. Examples of the binder resin include polyester, polycarbonate, polyvinyl butyral, acrylic resin, silicone resin, epoxy resin, melamine resin, urethane resin, phenolic resin, and alkyd resin. Examples of the solvent for the conductive layer-forming coating liquid include ether solvents, alcohol solvents, ketone solvents, and aromatic hydrocarbon solvents.

The thickness of the conductive layer is preferably 5 to 40 μm and more preferably 10 to 30 μm.

An undercoat layer (also referred to as an intermediate layer) having a barrier function and an adhesive function may also be disposed between the support and the photosensitive layer. The undercoat layer can be formed by forming a coating film of an undercoat layer-forming coating solution prepared by mixing a binder resin and a solvent and drying the coating film.

Examples of the binder resin used for the undercoat layer include polyvinyl alcohol, polyethylene oxide, ethyl cellulose, methyl cellulose, casein, polyamide, glue, and gelatin. The thickness of the undercoat layer is preferably 0.1 to 10 μm and more preferably 0.3 to 5.0 μm. Photosensitive layer, Charge generating layer

When the photosensitive layer is a multilayer type photosensitive layer, the charge generating layer contains, as a charge generation material, the chlorogallium phthalocyanine crystal according to an embodiment of present invention. The charge generating layer can be formed by forming a coating film of a charge generating layer-forming coating solution prepared by mixing the chlorogallium phthalocyanine crystal and a binder resin in a solvent and drying the coating film. When the chlorogallium phthalocyanine crystal is dispersed, the crystal form of the chlorogallium phthalocyanine crystal does not change as long as the binder resin is added.

The thickness of the charge generating layer is preferably 0.05 to 1 μm and more preferably 0.1 to 0.3 μm.

The content of the charge generation material in the charge generating layer is preferably 30 to 90 mass % and more preferably 50 to 80 mass % based on the total mass of the charge generating layer.

Materials other than the chlorogallium phthalocyanine crystal according to an embodiment of the present invention may also be used as the charge generation material in the charge generating layer. In this case, the content of the chlorogallium phthalocyanine crystal according to an embodiment of the present invention is, for example, 50 mass % or more based on the total mass of the charge generation material.

Examples of the binder resin used for the charge generating layer include polyester, acrylic resin, phenoxy resin, polycarbonate, polyvinyl butyral, polystyrene, polyvinyl acetate, polysulfone, polyarylate, vinylidene chloride, acrylonitrile copolymers, and polyvinyl benzal. Among them, polyvinyl butyral and polyvinyl benzal are particularly used.

### Photosensitive Layer, Charge Transporting Layer

The charge transporting layer can be formed by forming a coating film of a charge transporting layer-forming coating solution prepared by dissolving a charge transport material and a binder resin in a solvent and drying the coating film.

Examples of the charge transport material include triarylamine compounds, hydrazone compounds, stilbene compounds, pyrazoline compounds, oxazole compounds, thiazole compounds, and triarllylmethane compounds. Among them, a triarylamine compound is particularly used.

Examples of the binder resin used for the charge transporting layer include polyester, acrylic resin, phenoxy resin, polycarbonate, polystyrene, polyvinyl acetate, polysulfone, polyarylate, vinylidene chloride, and acrylonitrile copolymers. Among them, polycarbonate and polyarylate are particularly used.

The thickness of the charge transporting layer is preferably 5 to 40 μm and more preferably 10 to 25 μm. The content of the charge transport material in the charge transporting layer is preferably 20 to 80 mass % and more preferably 30 to 60 mass % based on the total mass of the charge transporting layer.

When the photosensitive layer is a single-layer type photosensitive layer, the single-layer type photosensitive layer can be formed by forming a coating film of a single-layer type photosensitive layer-forming coating solution and drying the coating film. The single-layer type photosensitive layer-forming coating solution can be prepared by mixing the chlorogallium phthalocyanine crystal according to an embodiment of the present invention serving as a charge generation material, a charge transport material, a binder resin, and a solvent.

A protective layer may be disposed on the photosensitive layer in order to protect the photosensitive layer.

The protective layer can be formed by forming a coating film of a protective layer-forming coating solution prepared by dissolving a binder resin in a solvent and drying the coating film. Examples of the binder resin used for the protective layer include polyvinyl butyral, polyester, polycarbonate, nylon, polyimide, polyarylate, polyurethane, styrene-butadiene copolymers, styrene-acrylic acid copolymers, and styrene-acrylonitrile copolymers.

To provide charge transportability to the protective layer, the protective layer may be formed by curing a monomer having charge transportability (hole transportability) through a polymerization reaction or a cross-linking reaction. Specifically, the protective layer can be formed by curing a charge transporting compound (hole transporting compound) having a chain-polymerizable functional group through polymerization or cross-linking.

The thickness of the protective layer is, for example, 0.05 to 20 μm.

Examples of a method for applying the coating solutions for the above-described layers include dipping, spray coating, spinner coating, bead coating, blade coating, and beam coating.

The layer serving as a surface layer of the electrophotographic photosensitive member may contain conductive particles, an ultraviolet absorber, and lubricant particles such as fluorine-containing resin particles. The conductive particles are, for example, metal oxide particles such as tin oxide particles.

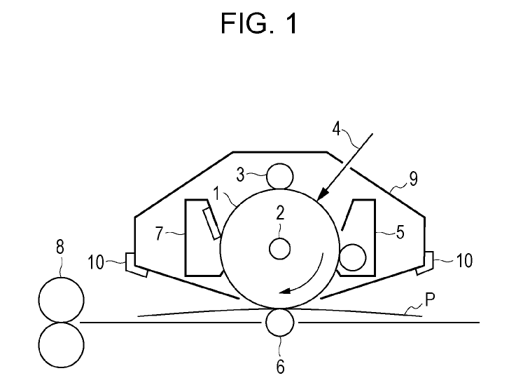

FIG. 1 illustrates an example of a schematic structure of an electrophotographic apparatus that includes a process cartridge including an electrophotographic photosensitive member.

A cylindrical (drum-shaped) electrophotographic photosensitive member 1 is rotated about a shaft 2 at a predetermined peripheral speed (process speed) in a direction indicated by an arrow.

In the rotation, the surface (peripheral surface) of the electrophotographic photosensitive member 1 is charged at a predetermined positive or negative potential by a charging device (primary charging device) 3. The surface of the electrophotographic photosensitive member 1 is then irradiated with exposure light (image exposure light) 4 emitted from an exposure device (image exposure device, not illustrated). Thus, an electrostatic latent image corresponding to intended image information is formed on the surface of the electrophotographic photosensitive member 1. The exposure light 4 is, for example, intensity-modulated light emitted from an exposure device such as a slit exposure device or a laser beam scanning exposure device, in response to the time-series electric digital image signals of the intended image information.

The electrostatic latent image formed on the surface of the electrophotographic photosensitive member 1 is subjected to development (normal or reversal development) with a developing agent (toner) contained in a developing device 5, and thus a toner image is formed on the surface of the electrophotographic photosensitive member 1. The toner image formed on the surface of the electrophotographic photosensitive member 1 is transferred onto a transfer material P by a transfer device 6. Herein, a voltage (transfer bias) having polarity opposite to the polarity of the electric charge of the toner is applied to the transfer device 6 from a bias power supply (not illustrated). The transfer material P is fed to a portion between the electrophotographic photosensitive member 1 and the transfer device 6 from a transfer material feeding device (not illustrated) in synchronism with the rotation of the electrophotographic photosensitive member 1.

The transfer material P onto which the toner image has been transferred is separated from the surface of the electrophotographic photosensitive member 1 and is conveyed to a fixing device 8. After the toner image is fixed, the transfer material P is output from the electrophotographic apparatus as an image-formed article (such as a print or a copy).

The surface of the electrophotographic photosensitive member 1 after the toner image has been transferred onto the transfer material P is cleaned by removing deposits such as a residual developing agent (residual toner) with a cleaning member 7. Such a residual toner can also be collected by a developing device or the like (cleanerless system).

Furthermore, the surface of the electrophotographic photosensitive member 1 is irradiated with pre-exposure light (not illustrated) from a pre-exposure device (not illustrated) to remove electricity, and then the electrophotographic photosensitive member 1 is repeatedly used for image forming. In the case where the charging device 3 is a contact charging device that uses a charging roller or the like as illustrated in FIG. 1, the pre-exposure device is not necessarily required.

A plurality of components selected from the components such as the electrophotographic photosensitive member 1, the charging device 3, the developing device 5, the transfer device 6, and the cleaning member 7 may be incorporated in a container and integrally supported to provide a process cartridge. The process cartridge may be detachably attachable to the main body of an electrophotographic apparatus. For example, the electrophotographic photosensitive member 1 and at least one selected from the charging device 3, the developing device 5, and the cleaning member 7 are integrally supported to provide a process cartridge 9, which is detachably attachable to the main body of an electrophotographic apparatus using a guide unit 10 such as a rail of the main body.

In the case where the electrophotographic apparatus is a copying machine or a printer, the exposure light 4 may be reflected light from a document or transmitted light. Alternatively, the exposure light 4 may be light applied by, for example, scanning with a laser beam according to signals into which a document read by a sensor is converted, driving of an LED array, or driving of a liquid-crystal shutter array.

### EXAMPLES

Hereafter, the present invention will be further described in detail based on specific examples, but is not limited thereto. “Part” used below means “part by mass”. The thickness of each layer of electrophotographic photosensitive members in Examples and Comparative Examples was determined by using an eddy current thickness meter (Fischerscope, manufactured by Fischer Instruments) or by conversion from the mass per unit area using specific gravity.

### Synthesis Example 1

After 36.7 parts of orthophthalonitrile, 25 parts of gallium trichloride, and 300 parts of α-chloronaphthalene were reacted with each other in a nitrogen atmosphere at 200° C. for 5.5 hours, the resulting product was filtered at 130° C. The product was washed by dispersion using N,N-dimethylformamide at 140° C. for 2 hours and then filtered. The filter residue was washed with methanol and dried to obtain 46 parts of chlorogallium phthalocyanine. The chlorogallium phthalocyanine was a crystal with a crystal form having peaks at Bragg angles 2θ of 7.4°, 16.6°, 25.5°, and 28.3° in CuKα X-ray diffraction.

### Synthesis Example 2

After 30 parts of 1,3-diiminoisoindoline, 8 parts of gallium trichloride, and 230 parts of dimethylsulfoxide were reacted with each other in a nitrogen atmosphere at 160° C. for 6 hours, the resulting product was filtered at 130° C. The product was washed by dispersion using N,N-dimethylformamide at 140° C. for 2 hours and then filtered. The filter residue was washed with methanol and dried to obtain 28 parts of chlorogallium phthalocyanine. The chlorogallium phthalocyanine was a crystal with a crystal form having a peak at a Bragg angle 2θ of 27.1° in CuKα X-ray diffraction.

### Example 1

### Acid Pasting Step

Twenty-four parts of the chlorogallium phthalocyanine obtained in Synthesis Example 1 was dissolved in 750 parts of concentrated sulfuric acid at 5° C. The mixture was dropped into 2500 parts of ice water under stirring to perform reprecipitation, and filtration was performed under reduced pressure. Herein, No. 5C (manufactured by ADVANTEC Co., LTD.) was used as the filter. Subsequently, the filter residue was washed by dispersion using 2% ammonia water for 30 minutes, and then washed by dispersion using ion-exchanged water four times. Finally, freeze drying was performed and thus a hydroxygallium phthalocyanine crystal was obtained at a yield of 97%. The hydroxygallium phthalocyanine crystal was a crystal with a crystal form having peaks at Bragg angles 2θ of 6.9° and 26.4° in CuKα X-ray diffraction.

### Hydrochloric Acid Treatment Step

Ten parts of the hydroxygallium phthalocyanine crystal obtained in the acid pasting step and 200 parts of an aqueous hydrochloric acid solution at 23° C. with a concentration of 35 mass % were mixed with each other and stirred using a magnetic stirrer for 90 minutes. The aqueous hydrochloric acid solution added contained 118 mol of hydrochloric acid based on 1 mol of the hydroxygallium phthalocyanine. After the stirring, the mixture was dropped into 1000 parts of ion-exchanged water cooled with ice water, and stirred using a magnetic stirrer for 30 minutes. Filtration was performed under reduced pressure. Herein, No. 5C (manufactured by ADVANTEC Co., LTD.) was used as the filter. Subsequently, the filter residue was washed by dispersion using ion-exchanged water at 23° C. four times. Thus, 9 parts of a chlorogallium phthalocyanine crystal was obtained. The chlorogallium phthalocyanine crystal was a crystal with a crystal form having peaks at Bragg angles 2θ of 7.1°, 16.6°, 25.7°, 27.4°, and 28.3° in CuKα X-ray diffraction.

### Wet Milling Step

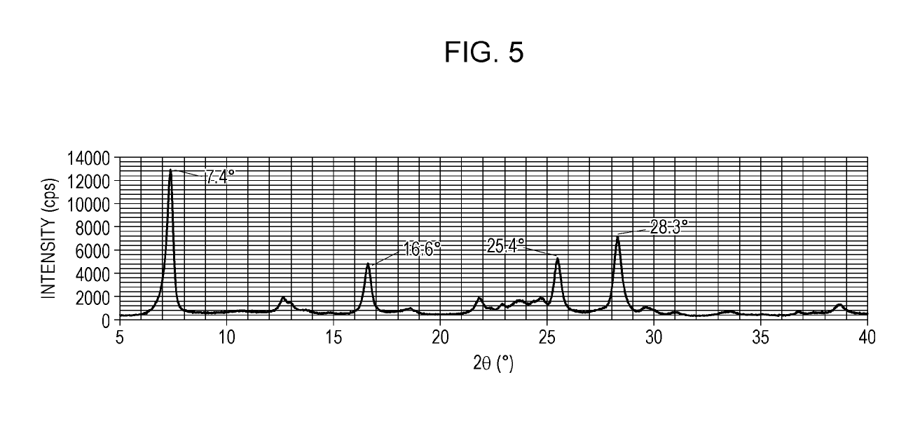

At room temperature (23° C.), 0.5 parts of the chlorogallium phthalocyanine crystal obtained in the hydrochloric acid treatment step, 10 parts of N-methylformamide serving as an organic compound, and 15 parts of glass beads having a diameter of 1 mm were subjected to a milling treatment for 24 hours using a ball mill. A chlorogallium phthalocyanine crystal was extracted from the resulting dispersion liquid using tetrahydrofuran and filtered, and the resulting filter residue on the filter was thoroughly washed using tetrahydrofuran. The filter residue was vacuum-dried to obtain 0.43 parts of a chlorogallium phthalocyanine crystal. The chlorogallium phthalocyanine crystal was a crystal with a crystal form having peaks at Bragg angles 2θ of 7.4°, 16.6°, 25.4°, and 28.3° in CuKα X-ray diffraction. FIG. 5 illustrates the measurement result (X-ray diffraction pattern) of the crystal form.

It was confirmed from the H-NMR measurement that the content of the N-methylformamide was 0.41 mass % based on the chlorogallium phthalocyanine in the chlorogallium phthalocyanine crystal in terms of proton ratio.

### Step of Producing Electrophotographic Photosensitive Member

An aluminum cylinder (JIS-A3003, aluminum alloy) having a diameter of 24 mm and a length of 257.5 mm was used as a support (conductive support).

First, 60 parts of barium sulfate particles coated with tin oxide (trade name: Passtran PC1, manufactured by MITSUI MINING & SMELTING Co., Ltd.), 15 parts of titanium oxide particles (trade name: TITANIX JR, manufactured by TAYCA CORPORATION), 43 parts of resole phenolic resin (trade name: Phenolite J-325, manufactured by DIC Corporation, solid content: 70 mass %), 0.015 parts of silicone oil (trade name: SH28PA, manufactured by Dow Corning Toray Co., Ltd.), 3.6 parts of silicone resin particles (trade name: Tospearl 120, manufactured by Toshiba Silicone Co., Ltd.), 50 parts of 2-methoxy-1-propanol, and 50 parts of methanol were inserted into a ball mill and dispersed for 20 hours to prepare a conductive layer-forming coating solution. The conductive layer-forming coating solution was applied onto the support by dipping to form a coating film. The coating film was cured by performing heating at 140° C. for 1 hour to form a conductive layer having a thickness of 15 μm.

Subsequently, 10 parts of copolymer nylon (trade name: Amilan CM8000, manufactured by Toray Industries, Inc.) and 30 parts of methoxymethylated 6 nylon (trade name: Toresin EF-30T, manufactured by Teikoku Chemical Industries Co., Ltd.) were dissolved in a mixed solvent of methanol 400 parts/n-butanol 200 parts to prepare an undercoat layer-forming coating solution. The undercoat layer-forming coating solution was applied onto the conductive layer by dipping to form a coating film. The coating film was dried at 80° C. for 6 minutes to form an undercoat layer having a thickness of 0.42 μm.

Subsequently, 2 parts of the chlorogallium phthalocyanine crystal (charge generation material) obtained in the wet milling step, 1 part of polyvinyl butyral (trade name: S-LEC BX-1, manufactured by SEKISUI CHEMICAL CO., LTD.), and 52 parts of cyclohexanone were inserted into a sand mill that uses glass beads having a diameter of 1 mm and dispersed for 6 hours. Then, 75 parts of ethyl acetate was added thereto to prepare a charge generating layer-forming coating solution. The charge generating layer-forming coating solution was applied onto the undercoat layer by dipping to form a coating film. The coating film was dried at 100° C. for 10 minutes to form a charge generating layer having a thickness of 0.20 μm.

Subsequently, 28 parts of a compound represented by formula (C-1) below (charge transport material (hole transport compound)),

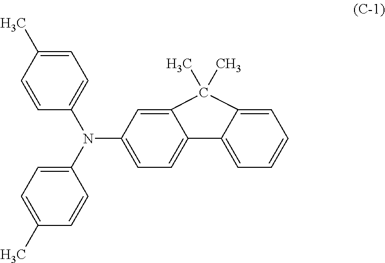 [SMILES: Cc1ccc(N(c2ccc(C)cc2)c2ccc3c(c2)C(C)(C)c2ccccc2-3)cc1]

4 parts of a compound represented by formula (C-2) below (charge transport material (hole transport compound)), and

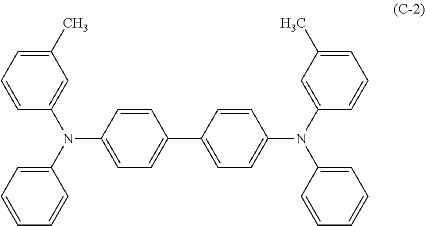 [SMILES: Cc1cccc(N(c2ccccc2)c2ccc(-c3ccc(N(c4ccccc4)c4cccc(C)c4)cc3)cc2)c1]

40 parts of polycarbonate (trade name: Iupilon 2200, manufactured by Mitsubishi Engineering-Plastics Corporation) were dissolved in a mixed solvent of monochlorobenzene 200 parts/dimethoxymethane 50 parts to prepare a charge transporting layer-forming coating solution. The charge transporting layer-forming coating solution was applied onto the charge generating layer by dipping to form a coating film. The coating film was dried at 120° C. for 30 minutes to form a charge transporting layer having a thickness of 18 μm.

Thus, a cylindrical (drum-shaped) electrophotographic photosensitive member of Example 1 was produced.

### Example 2

An electrophotographic photosensitive member was produced in the same manner as in Example 1, except that the chlorogallium phthalocyanine of Synthesis Example 1 used in the acid pasting step was changed to the chlorogallium phthalocyanine of Synthesis Example 2, and the treatment time of the wet milling step was changed to 1 hour.

### Example 3

At room temperature (23° C.), 0.5 parts of the chlorogallium phthalocyanine obtained in Synthesis Example 1 and 15 parts of glass beads having a diameter of 1 mm were subjected to a milling treatment using a paint shaker for 24 hours to obtain a fine chlorogallium phthalocyanine crystal. An electrophotographic photosensitive member of Example 3 was produced in the same manner as in the wet milling step and the step of producing an electrophotographic photosensitive member in Example 1, except that the wet milling step was performed using the resulting chlorogallium phthalocyanine crystal for 120 hours. In Example 3, the acid pasting step and the hydrochloric acid treatment step were not performed.

### Example 4

An electrophotographic photosensitive member was produced in the same manner as in Example 3, except that the treatment time of the wet milling step was changed to 4 hours.

### Example 5

An electrophotographic photosensitive member was produced in the same manner as in Example 1, except that 10 parts of N-methylformamide used in the wet milling step was changed to 10 parts of N-methylacetamide.

### Example 6

An electrophotographic photosensitive member was produced in the same manner as in Example 2, except that 10 parts of N-methylformamide used in the wet milling step was changed to 10 parts of N-methylacetamide.

### Example 7

An electrophotographic photosensitive member was produced in the same manner as in Example 3, except that 10 parts of N-methylformamide used in the wet milling step was changed to 10 parts of N-methylacetamide.

### Example 8

An electrophotographic photosensitive member was produced in the same manner as in Example 4, except that 10 parts of N-methylformamide used in the wet milling step was changed to 10 parts of N-methylacetamide.

### Examples 9 to 14

An electrophotographic photosensitive member was produced in the same manner as in Example 1, except that the N-methylformamide used in the wet milling step was changed to an organic compound listed in Table 2.

In Examples 1 to 14, the chlorogallium phthalocyanine crystal after the wet milling step contains a mixture of a chlorogallium phthalocyanine in which all of X₁ to X₄ in the formula (1) represent a hydrogen atom and a chlorogallium phthalocyanine in which one of X₁ to X₄ in the formula (1) represents a chlorine atom.

### Comparative Example 1

An electrophotographic photosensitive member was produced in the same manner as in Example 3, except that the N-methylformamide used in the wet milling step was changed to N,N-dimethylformamide.

### Comparative Example 2

An electrophotographic photosensitive member was produced in the same manner as in Example 3, except that the N-methylformamide used in the wet milling step was changed to dimethylsulfoxide.

### Comparative Example 4

An electrophotographic photosensitive member was produced in the same manner as in Example 1, except that the N-methylformamide used in the wet milling step was changed to benzyl alcohol.

### Comparative Example 5

An electrophotographic photosensitive member was produced in the same manner as in Example 2, except that the N-methylformamide used in the wet milling step was changed to benzyl alcohol.

### Comparative Example 6

An electrophotographic photosensitive member was produced in the same manner as in Example 3, except that the N-methylformamide used in the wet milling step was changed to benzyl alcohol.

### Comparative Example 7

An electrophotographic photosensitive member was produced in the same manner as in Example 4, except that the N-methylformamide used in the wet milling step was changed to benzyl alcohol.

### Comparative Examples 8 to 22

An electrophotographic photosensitive member was produced in the same manner as in Example 1, except that the N-methylformamide used in the wet milling step was changed to an organic compound listed in Table 3.

### Evaluation of Examples 1 to 14 and Comparative Examples 1 to 22

A ghost image was evaluated for the electrophotographic photosensitive members produced in Examples and Comparative Examples in a normal-temperature and normal-humidity environment of 23° C./50%. The evaluation was performed using a converted printer of a laser beam printer (trade name: LaserJet Pro 400 Color M451dn) manufactured by Hewlett-Packard Company. The printer was converted such that the amount of exposure light (image exposure light) can be changed.

The produced electrophotographic photosensitive member was set in a process cartridge for cyan. A cartridge for development was removed from the device and a potential measuring instrument was inserted thereinto. This is set in a station of the process cartridge for cyan in the printer, and the amount of exposure light was adjusted so that the light-area potential (Vl) was −150 V. The potential measuring instrument included a potential probe (trade name: model 6000B-8, manufactured by TREK JAPAN) disposed at a development position of the cartridge for development. The potential probe was located at the center of the electrophotographic photosensitive member in a drum-axis direction. The potential at the center of the electrophotographic photosensitive member was measured with a surface electrometer (trade name: model 344, manufactured by TREK JAPAN).

Subsequently, the potential measuring instrument was removed, and the cartridge for development was reinstalled. The initial ghost image was evaluated.

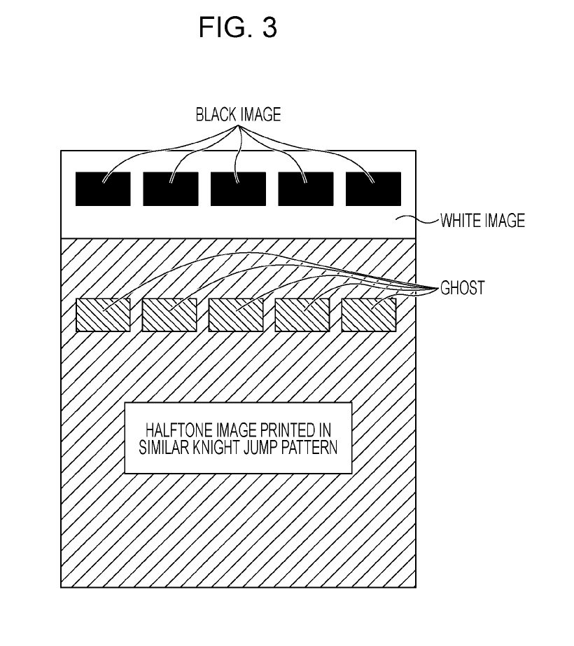

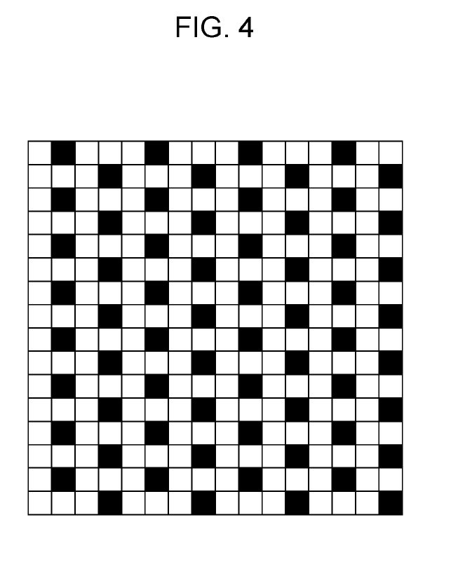

FIG. 3 illustrates an image for ghost evaluation. Quadrilateral black images were output in a white image at the top part of an image and then a halftone image was output. The halftone image was printed in a similar knight jump pattern illustrated in FIG. 4.

The ghost images were evaluated using a SpectroDensitometer (trade name: X-Rite 504/508 manufactured by X-Rite Inc.). On the output image, the Macbeth density of the halftone image of the similar knight jump pattern was subtracted from the Macbeth density of a ghost portion (a portion where a ghost may be generated), which was defined as a ghost image density. This evaluation was performed at ten points in a single output image, and the average of ghost image densities at the ten points was determined.

In this experiment, a ghost image density of 0.05 or more was a level at which the effects of the present invention were not produced, and a ghost image density of less than 0.05 was a level at which the effects of the present invention were produced.

Tables 2 and 3 show the results.

TABLE 2

| | | | | | | | | | | Evaluation |
|---|---|---|---|---|---|---|---|---|---|---|
| | | | Wet milling step | | | | | | | Difference |
| | | | Treat- | Compound | | | | | Crystal form after the step | in ghost |
| | Synthesis | Conversion | ment | used in wet | | | | Content | Bragg angle 2θ in CuKα X- | image |
| | step | pretreatment | time | treatment | δtotal | δP | δD | (%) | ray diffraction | density |
| Example 1 | Synthesis | Acid pasting step and | 24 | N-Methyl- | 29.2 | 17.8 | 17.9 | 0.41 | 7.4°, 16.6°, 25.5°, and | 0.023 |
| | Example 1 | hydrochloric acid | | formamide | | | | | 28.4° | |
| | | treatment step | | | | | | | | |
| Example 2 | Synthesis | Acid pasting step and | 1 | | | | | 0.29 | 7.4°, 16.6°, 25.5°, and | 0.028 |
| | Example 2 | hydrochloric acid | | | | | | | 28.4° | |
| | | treatment step | | | | | | | | |
| Example 3 | Synthesis | Dry milling step | 120 | | | | | 1.31 | 7.4°, 16.6°, 25.5°, and | 0.030 |
| | Example 1 | | | | | | | | 28.4° | |
| Example 4 | Synthesis | Dry milling step | 4 | | | | | 1.85 | 7.4°, 16.6°, 25.5°, and | 0.049 |
| | Example 1 | | | | | | | | 28.4° | |
| Example 5 | Synthesis | Acid pasting step and | 24 | N-Methyl- | 25.5 | 14.8 | 18.0 | 0.34 | 7.4°, 16.6°, 25.5°, and | 0.024 |
| | Example 1 | hydrochloric acid | | acetamide | | | | | 28.4° | |
| | | treatment step | | | | | | | | |
| Example 6 | Synthesis | Acid pasting step and | 1 | | | | | 0.21 | 7.4°, 16.6°, 25.5°, and | 0.029 |
| | Example 2 | hydrochloric acid | | | | | | | 28.4° | |
| | | treatment step | | | | | | | | |
| Example 7 | Synthesis | Dry milling step | 120 | | | | | 1.12 | 7.4°, 16.6°, 25.5°, and | 0.030 |
| | Example 1 | | | | | | | | 28.4° | |
| Example 8 | Synthesis | Dry milling step | 4 | | | | | 1.56 | 7.4°, 16.6°, 25.5°, and | 0.048 |
| | Example 1 | | | | | | | | 28.4° | |
| Example 9 | Synthesis | Acid pasting step and | 24 | N-Vinyl- | 27.2 | 16.0 | 17.5 | 0.46 | 7.4°, 16.6°, 25.5°, and | 0.032 |
| | Example 1 | hydrochloric acid | | formamide | | | | | 28.4° | |
| | | treatment step | | | | | | | | |
| Example 10 | Synthesis | Acid pasting step and | 24 | 2-Pyrrolidone | 25.1 | 13.7 | 19.3 | 0.28 | 7.4°, 16.6°, 25.5°, and | 0.033 |
| | Example 1 | hydrochloric acid | | | | | | | 28.4° | |
| | | treatment step | | | | | | | | |
| Example 11 | Synthesis | Acid pasting step and | 24 | N-Methyl- | 27.5 | 18.4 | 17.5 | 0.49 | 7.4°, 16.6°, 25.5°, and | 0.038 |
| | Example 1 | hydrochloric acid | | methane- | | | | | 28.4° | |
| | | treatment step | | sulfonamide | | | | | | |
| Example 12 | Synthesis | Acid pasting step and | 24 | N-Propyl- | 24.4 | 13.6 | 16.9 | 0.39 | 7.4°, 16.6°, 25.5°, and | 0.039 |
| | Example 1 | hydrochloric acid | | formamide | | | | | 28.4° | |
| | | treatment step | | | | | | | | |
| Example 13 | Synthesis | Acid pasting step and | 24 | Acetonitrile | 24.0 | 16.2 | 16.2 | 0.18 | 7.4°, 16.6°, 25.5°, and | 0.042 |
| | Example 1 | hydrochloric acid | | | | | | | 28.4° | |
| | | treatment step | | | | | | | | |
| Example 14 | Synthesis | Acid pasting step and | 24 | Formamide | 33.7 | 20.3 | 17.7 | 0.52 | 7.4°, 16.6°, 25.5°, and | 0.041 |
| | Example 1 | hydrochloric acid | | | | | | | 28.4° | |
| | | treatment step | | | | | | | | |

TABLE 3

| | | | | | | | | | | Evaluation |
|---|---|---|---|---|---|---|---|---|---|---|
| | | | Wet milling step | | | | | | | Difference |
| | | | Treat- | Compound | | | | | Crystal form after the step | in ghost |
| | Synthesis | Conversion | ment | used in wet | | | | Content | Bragg angle 2θ in CuKα X- | image |
| | step | pretreatment | time | treatment | δtotal | δP | δD | (%) | ray diffraction | density |
| Comparative | Synthesis | Dry milling step | 120 | N,N-Dimethyl- | 24.2 | 13.3 | 17.0 | — | 7.4°, 16.6°, 25.5°, and | 0.058 |
| Example 1 | Example 1 | | | formamide | | | | | 28.4° | |
| Comparative | Synthesis | Dry milling step | 120 | Dimethyl- | 23.7 | 14.3 | 17.4 | — | 7.4°, 16.6°, 25.5°, and | 0.060 |
| Example 2 | Example 1 | | | sulfoxide | | | | | 28.4° | |
| Comparative | Synthesis | Acid pasting step and | 24 | Benzyl alcohol | 23.2 | 6.2 | 18.6 | — | 7.4°, 16.6°, 25.5°, and | 0.056 |
| Example 4 | Example 1 | hydrochloric acid | | | | | | | 28.4° | |
| | | treatment step | | | | | | | | |
| Comparative | Synthesis | Acid pasting step and | 1 | | | | | — | 7.4°, 16.6°, 25.5°, and | 0.058 |
| Example 5 | Example 2 | hydrochloric acid | | | | | | | 28.4° | |
| | | treatment step | | | | | | | | |
| Comparative | Synthesis | Dry milling step | 120 | | | | | — | 7.4°, 16.6°, 25.5°, and | 0.061 |
| Example 6 | Example 1 | | | | | | | | 28.4° | |
| Comparative | Synthesis | Dry milling step | 4 | | | | | — | 7.4°, 16.6°, 25.5°, and | 0.059 |
| Example 7 | Example 1 | | | | | | | | 28.4° | |
| Comparative | Synthesis | Acid pasting step and | 24 | Pyridine | 21.5 | 7.5 | 18.9 | — | 7.4°, 16.6°, 25.5°, and | 0.065 |
| Example 8 | Example 1 | hydrochloric acid | | | | | | | 28.4° | |
| | | treatment step | | | | | | | | |
| Comparative | Synthesis | Acid pasting step and | 24 | Triethylamine | 14.9 | 0.0 | 15.0 | — | 7.4°, 16.6°, 25.5°, and | 0.066 |
| Example 9 | Example 1 | hydrochloric acid | | | | | | | 28.4° | |
| | | treatment step | | | | | | | | |
| Comparative | Synthesis | Acid pasting step and | 24 | Toluene | 18.4 | 3.0 | 17.8 | — | 7.4°, 16.6°, 25.5°, and | 0.069 |
| Example 10 | Example 1 | hydrochloric acid | | | | | | | 28.4° | |
| | | treatment step | | | | | | | | |
| Comparative | Synthesis | Acid pasting step and | 24 | Quinoline | 21.5 | 5.6 | 19.8 | — | 7.4°, 16.6°, 25.5°, and | 0.076 |
| Example 11 | Example 1 | hydrochloric acid | | | | | | | 28.4° | |
| | | treatment step | | | | | | | | |
| Comparative | Synthesis | Acid pasting step and | 24 | Chlorobenzene | 19.4 | 4.0 | 18.5 | — | 7.4°, 16.6°, 25.5°, and | 0.073 |
| Example 12 | Example 1 | hydrochloric acid | | | | | | | 28.4° | |
| | | treatment step | | | | | | | | |
| Comparative | Synthesis | Acid pasting step and | 24 | Butanol | 23.0 | 6.4 | 15.9 | — | 7.4°, 16.6°, 25.5°, and | 0.082 |
| Example 13 | Example 1 | hydrochloric acid | | | | | | | 28.4° | |
| | | treatment step | | | | | | | | |
| Comparative | Synthesis | Acid pasting step and | 24 | m- | 21.9 | 5.5 | 18.5 | — | 7.4°, 16.6°, 25.5°, and | 0.092 |
| Example 14 | Example 1 | hydrochloric acid | | Tolylcarbinol | | | | | 28.4° | |
| | | treatment step | | | | | | | | |
| Comparative | Synthesis | Acid pasting step and | 24 | Water | 31.8 | 10.0 | 17.9 | — | 7.4°, 16.6°, 25.5°, and | 0.095 |
| Example 15 | Example 1 | hydrochloric acid | | | | | | | 28.4° | |
| | | treatment step | | | | | | | | |
| Comparative | Synthesis | Acid pasting step and | 24 | Ethylene glycol | 31.6 | 11.1 | 18.0 | — | 7.4°, 16.6°, 25.5°, and | 0.092 |
| Example 16 | Example 1 | hydrochloric acid | | | | | | | 28.4° | |
| | | treatment step | | | | | | | | |
| Comparative | Synthesis | Acid pasting step and | 24 | Ethanol | 25.4 | 8.6 | 16.2 | — | 7.4°, 16.6°, 25.5°, and | 0.098 |
| Example 17 | Example 1 | hydrochloric acid | | | | | | | 28.4° | |
| | | treatment step | | | | | | | | |
| Comparative | Synthesis | Acid pasting step and | 24 | Methanol | 30.5 | 11.1 | 17.4 | — | 7.4°, 16.6°, 25.5°, and | 0.092 |
| Example 18 | Example 1 | hydrochloric acid | | | | | | | 28.4° | |
| | | treatment step | | | | | | | | |
| Comparative | Synthesis | Acid pasting step and | 24 | Methylene | 21.1 | 8.1 | 17.4 | — | 7.4°, 16.6°, 25.5°, and | 0.097 |
| Example 19 | Example 1 | hydrochloric acid | | chloride | | | | | 28.4° | |
| | | treatment step | | | | | | | | |
| Comparative | Synthesis | Acid pasting step and | 24 | 1-Hydroxy- | 27.5 | 14.3 | 20.6 | — | 7.4°, 16.6°, 25.5°, and | 0.059 |
| Example 20 | Example 1 | hydrochloric acid | | anthraquinone | | | | | 28.4° | |
| | | treatment step | | | | | | | | |
| Comparative | Synthesis | Acid pasting step and | 24 | Phthalimide | 30.6 | 18.4 | 21.0 | — | 7.4°, 16.6°, 25.5°, and | 0.062 |
| Example 21 | Example 1 | hydrochloric acid | | | | | | | 28.4° | |
| | | treatment step | | | | | | | | |
| Comparative | Synthesis | Acid pasting step and | 24 | Phthalic | 25.0 | 14.4 | 21.2 | — | 7.4°, 16.6°, 25.5°, and | 0.065 |
| Example 22 | Example 1 | hydrochloric acid | | anhydride | | | | | 28.4° | |
| | | treatment step | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-122841, filed Jun. 13, 2014, and No. 2014-220750, filed Oct. 29, 2014, which are hereby incorporated by reference herein in their entirety.

What is claimed is:

1. An electrophotographic photosensitive member comprising:
a support; and
a photosensitive layer on the support;
wherein the photosensitive layer comprises:
a chlorogallium phthalocyanine crystal in which an organic compound is contained,
the organic compound has a Hansen solubility parameter δtotal of 24.0 or more and 35.0 or less,
the organic compound has a polar energy δP of 13.5 or more and 21.0 or less,
the organic compound has a dispersion energy δD of 15.0 or more and 19.5 or less, and
the chlorogallium phthalocyanine crystal is a compound represented by the following formula (1), 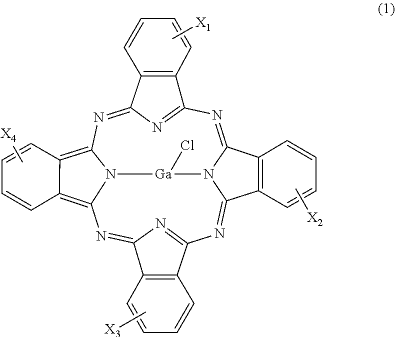
wherein, in the formula (1), X₁ to X₄ each independently represent a hydrogen atom or a chlorine atom.

2. The electrophotographic photosensitive member according to claim 1, wherein a content of the organic compound is 0.1 mass % or more and 1.5 mass % or less based on chlorogallium phthalocyanine in the chlorogallium phthalocyanine crystal.

3. The electrophotographic photosensitive member according to claim 1, wherein the chlorogallium phthalocyanine crystal has four major peaks at Bragg angles 2θ±0.2° of 7.4°, 16.6°, 25.5°, and 28.4° in CuKα X-ray diffraction.

4. The electrophotographic photosensitive member according to claim 1, wherein the organic compound is at least one selected from the group consisting of N-methylformamide, N-methylacetamide, N-vinylformamide, 2-pyrrolidone, N-methylmethanesulfonamide, N-propylformamide, acetonitrile, and formamide.

5. The electrophotographic photosensitive member according to claim 1, wherein the organic compound has a Hansen solubility parameter δtotal of 24.2 or more and 30.0 or less.

6. The electrophotographic photosensitive member according to claim 1, wherein the organic compound has a polar energy δP of 14.0 or more and 18.0 or less.

7. The electrophotographic photosensitive member according to claim 1, wherein the organic compound has a dispersion energy δD of 17.7 or more and 19.1 or less.

8. The electrophotographic photosensitive member according to claim 1, wherein the organic compound is at least one of N-methylformamide and N-methylacetamide.

9. A process cartridge detachably attachable to a main body of an electrophotographic apparatus, wherein the process cartridge integrally supports the electrophotographic photosensitive member according to claim 1 and at least one selected from the group consisting of a charging device, a developing device, a transfer device, and a cleaning member.

10. An electrophotographic apparatus comprising:
the electrophotographic photosensitive member according to claim 1;
a charging device;
an exposure device;
a developing device; and
a transfer device.

11. A method for producing the electrophotographic photosensitive member according to claim 1, the method comprising:
an acid pasting step of mixing chlorogallium phthalocyanine with sulfuric acid to obtain hydroxygallium phthalocyanine.

12. The method according to claim 11, sequentially comprising:
a synthesis step of synthesizing chlorogallium phthalocyanine by reacting a gallium compound and a compound that forms a phthalocyanine ring in a chlorinating aromatic compound;
a step of performing the acid pasting step using the chlorogallium phthalocyanine synthesized in the synthesis step to obtain the hydroxygallium phthalocyanine;
a hydrochloric acid treatment step of mixing the hydroxygallium phthalocyanine and an aqueous hydrochloric acid solution to obtain chlorogallium phthalocyanine;
a step of mixing the chlorogallium phthalocyanine obtained in the hydrochloric acid treatment step and the organic compound and performing a wet milling treatment to obtain the chlorogallium phthalocyanine crystal; and
a step of forming a photosensitive layer containing the chlorogallium phthalocyanine crystal.

13. The method according to claim 12, wherein the aqueous hydrochloric acid solution has a concentration of 10 mass % or more and contains 10 mol or more of hydrochloric acid based on 1 mol of the hydroxygallium phthalocyanine.

14. The method according to claim 12,
wherein the photosensitive layer comprises a charge generating layer containing the chlorogallium phthalocyanine crystal and a charge transporting layer formed on the charge generating layer, and
the step of forming a photosensitive layer is a step of forming the charge generating layer.

15. A chlorogallium phthalocyanine crystal comprising an organic compound therein,
wherein the organic compound has a Hansen solubility parameter δtotal of 24.0 or more and 35.0 or less,
the organic compound has a polar energy δP of 13.5 or more and 21.0 or less,
the organic compound has a dispersion energy δD of 15.0 or more and 19.5 or less, and
the chlorogallium phthalocyanine crystal is a compound represented by the following formula (1), 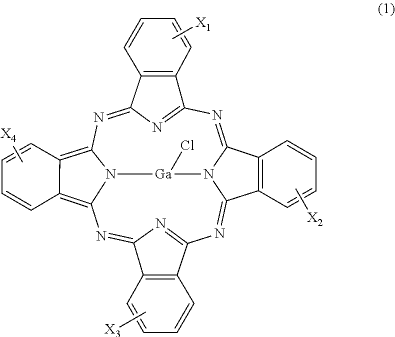
wherein, in the formula (1), X₁ to X₄ each independently represent a hydrogen atom or a chlorine atom.

16. The chlorogallium phthalocyanine crystal according to claim 15, wherein the chlorogallium phthalocyanine crystal has four major peaks at Bragg angles 2θ±0.2° of 7.4°, 16.6°, 25.5°, and 28.4° in CuKα X-ray diffraction.
